(19) United States
(12) Patent Application Publication
(10) Pub. No.: US 2026/0123673 A1
(43) Pub. Date: May 7, 2026

(54) AEROSOL GENERATING SUBSTRATE AND MICROWAVE HEATING METHOD

(71) Applicant: SMOORE INTERNATIONAL HOLDINGS LIMITED, Cayman Islands (GB)

(72) Inventors: Hang LI, Shenzhen (CN); Yongfu LI, Shenzhen (CN); Yongming LIU, Shenzhen (CN); Jun NI, Shenzhen (CN); Jing DU, Shenzhen (CN); Jianguo TANG, Shenzhen (CN)

(73) Assignee: SMOORE INTERNATIONAL HOLDINGS LIMITED, Cayman Islands (GB)

(21) Appl. No.: 19/434,570

(22) Filed: Dec. 29, 2025

Related U.S. Application Data
(63) Continuation of application No. PCT/CN2024/072300, filed on Jan. 15, 2024.

(30) Foreign Application Priority Data
Jun. 29, 2023 (CN) 202310787002.9

(51) Int. Cl. A24F 40/20

(52) U.S. Cl. CPC A24F 40/20

(57) ABSTRACT

Provided are an aerosol generating substrate (100) and a microwave heating method. The aerosol generating substrate (100) includes at least one aerosol release channel (10), and a thickness of a wall (20) of the aerosol generating substrate (100) defining the aerosol release channel (10) is 0.1 mm to 1.2 mm.

### CROSS-REFERENCE TO RELATED APPLICATION

This application is a continuation of International Patent Application No. PCT/CN2024/072300 filed on Jan. 15, 2024, which is based on and claims priority to Chinese Patent Application No. 202310787002.9 filed on Jun. 29, 2023, which is incorporated by reference in its entirety.

### TECHNICAL FIELD

The present disclosure relates to the technical field of smoke generating articles, and in particular to an aerosol generating substrate and a microwave heating method.

### BACKGROUND

An aerosol generating substrate typically generates an aerosol in a heat-not-burn manner. Specifically, the aerosol generating substrate is heated by an external heat source to a temperature just enough to release a fragrance. The aerosol generating substrate does not burn, but is loaded with an atomization agent, which is released by heating when used to form a smoke.

In related technologies, heating methods for the aerosol generating substrate include resistance heating, electromagnetic heating, microwave heating, etc. Before inhaling, the aerosol generating substrate needs to be preheated first; and after the preheating, the user can continuously inhale the aerosol generating substrate for the predetermined number of puffs to achieve the purpose of the aerosol inhalation.

However, in the related technologies, the solid structure of the aerosol generating substrate has a relatively high density. During heating, it is difficult for the aerosol to circulate within the solid structure of the aerosol generating substrate in a short time, or it is difficult for the aerosol to be released from the solid structure of the aerosol generating substrate to the outside environment. As such, a significant reduction is caused in the extraction efficiency of the aerosol generating substrate, making it unable to meet the requirement of immediate inhalation.

### SUMMARY

In view of the above, the embodiments of the present disclosure are expected to provide an aerosol generating substrate and a microwave heating method capable of improving the aerosol extraction efficiency.

In order to achieve the above objectives, an embodiment of the present disclosure provides an aerosol generating substrate. The aerosol generating substrate includes at least one aerosol release channel, and a thickness of a wall of the aerosol generating substrate defining the aerosol release channel is 0.1 mm to 1.2 mm.

In one embodiment, the thickness of the wall is 0.3 mm to 0.5 mm.

In one embodiment, a thickness difference of the wall at different positions of the aerosol generating substrate is 0 to 100%.

In one embodiment, the aerosol generating substrate is manufactured by extrusion process.

In one embodiment, for each aerosol release channel, a cross-sectional area of the aerosol release channels is S1, and a cross-sectional area of the wall for defining the aerosol release channel is S2, and S1:S2=1:1 to 5:1.

In one embodiment, the wall includes a first wall, and the first wall defines an outer contour of the aerosol generating substrate; and a portion of an inner surface of the first wall is recessed toward an outer side of the aerosol generating substrate, to enable a plurality of first grooves to be formed on an inner peripheral side of the first wall, where the plurality of first grooves are spaced apart.

In one embodiment, the wall includes a first wall, and the first wall defines an outer contour of the aerosol generating substrate; and a portion of an outer surface of the first wall is recessed toward an inner side of the aerosol generating substrate, to enable a plurality of second grooves to be formed on an outer peripheral side of the first wall, where the plurality of second grooves are spaced apart.

In one embodiment, the aerosol generating substrate includes a plurality of first grooves and a plurality of second grooves, and the plurality of first grooves and the plurality of second grooves are oppositely arranged in a one-to-one correspondence along a thickness direction of the wall.

In one embodiment, the wall includes a first wall and a second wall, the first wall defines an outer contour of the aerosol generating substrate and a hollow region located inside the aerosol generating substrate, and the second wall is disposed in the hollow region to partition the hollow region into at least two aerosol release channels.

In one embodiment, there are a plurality of second wall bodies, one side of each of the plurality of second wall bodies is respectively connected to the first wall, and an opposite side of each of the plurality of second wall bodies is interconnected with each other.

In one embodiment, the aerosol release channel includes at least one first aerosol release channel and a plurality of second aerosol release channels, and the plurality of second aerosol release channels surround the first aerosol release channel.

In one embodiment, the wall includes a first wall, a plurality of second wall bodies, and a third wall in an annular shape; the first wall defines an outer contour of the aerosol generating substrate and a hollow region located inside the aerosol generating substrate; the plurality of second wall bodies and the third wall are all disposed in the hollow region; one side of each of the second wall bodies is respectively connected to the first wall, and an opposite side of each of the second wall bodies is respectively connected to the third wall; the first aerosol release channel is defined in the third wall, and the second aerosol release channels are collectively defined by the first wall, the third wall and two adjacent second wall bodies.

In one embodiment, the wall is provided with an air hole.

In one embodiment, the wall includes a wave absorbing material.

In one embodiment, the wall is configured to absorb microwaves and produce heat to generate an aerosol.

In one embodiment, one end of the aerosol release channel is an open end penetrating a side of the aerosol generating substrate, and an opposite end of the aerosol release channel is a closed end.

In one embodiment, both ends of the aerosol release channel that are opposite to each other are open ends penetrating the aerosol generating substrate.

Another embodiment of the present disclosure provides a microwave heating method, which is used for the aerosol generating substrate described above; and the method includes the following operation.

The aerosol generating substrate is heated with microwaves to release an aerosol generated by the aerosol generating substrate into the aerosol release channel.

In one embodiment, there are a plurality of aerosol release channels, and the method includes the following operation.

A part of the wall defining the plurality of aerosol release channels is heated each time.

In one embodiment, the aerosol release channel includes at least one first aerosol release channel and a plurality of second aerosol release channels, and the plurality of second aerosol release channels surround the first aerosol release channel. The method includes the following operation.

A part of the wall defining the plurality of second aerosol release channels is heated each time.

The embodiments of the present disclosure provide the aerosol generating substrate and the microwave heating method. The aerosol generating substrate includes at least one aerosol release channel, and the thickness of a wall of the aerosol generating substrate defining the aerosol release channel is 0.1 mm to 1.2 mm. The thickness of the wall is set in the range from 0.3 mm to 0.5 mm, which can be conducive to the rapid release of the aerosol during the heating process. While improving the aerosol extraction efficiency, it can also ensure the carbonization rate of the aerosol generating substrate and further improve the utilization rate. In addition, in such thickness range, the aerosol generating substrate can have sufficient structural strength and be less susceptible to deformation.

### BRIEF DESCRIPTION OF THE DRAWINGS

FIG. 1 is a schematic structural diagram of a first aerosol generating substrate according to an embodiment of the present disclosure.

FIG. 2 is a schematic cross-sectional view of the aerosol generating substrate shown in FIG. 1.

FIG. 3 is a schematic structural diagram of a second aerosol generating substrate according to an embodiment of the present disclosure.

FIG. 4 is a schematic cross-sectional view of the aerosol generating substrate shown in FIG. 3.

FIG. 5 is a schematic structural diagram of a third aerosol generating substrate according to an embodiment of the present disclosure.

FIG. 6 is a schematic cross-sectional view of the aerosol generating substrate shown in FIG. 5.

FIG. 7 is a schematic structural diagram of a fourth aerosol generating substrate according to an embodiment of the present disclosure.

FIG. 8 is a schematic cross-sectional view of the aerosol generating substrate shown in FIG. 7.

FIG. 9 is a schematic cross-sectional view of a fifth aerosol generating substrate according to an embodiment of the present disclosure.

FIG. 10 is a schematic diagram of a microwave heating method according to an embodiment of the present disclosure.

### DETAILED DESCRIPTION

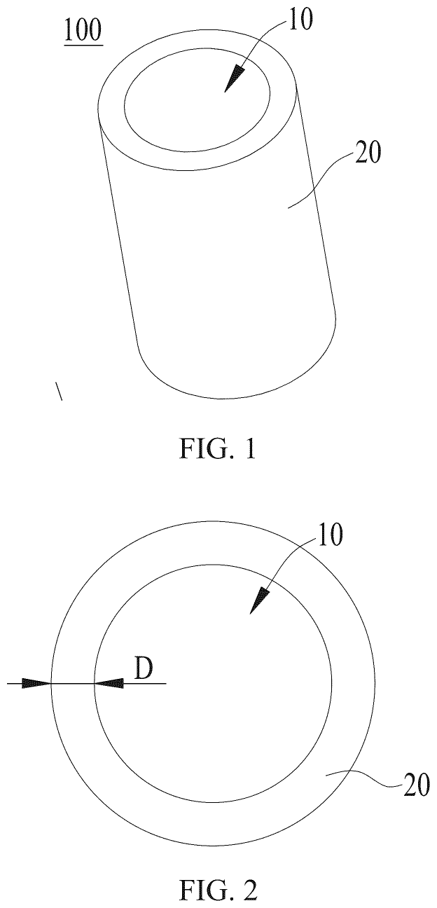

The embodiments of the present disclosure provide an aerosol generating substrate 100. Referring to FIGS. 1 to 9, the aerosol generating substrate 100 includes at least one aerosol release channel 10. Here, a thickness of a wall 20 (letter D in FIGS. 2, 4, 6 and 8 all indicates the thickness of each wall 20) of the aerosol generating substrate 100 defining the aerosol release channel 10 is 0.1 millimeter (mm) to 1.2 mm (inclusive of endpoint values).

The aerosol generating substrate 100 is used in conjunction with an aerosol generating device having a heating assembly. Specifically, the heating assembly heats and atomizes the aerosol generating substrate 100 to generate an aerosol for user inhalation or for medical, cosmetics, or the like.

There are various heating methods of the heating assembly. For example, the heating methods include a central heating method and a peripheral heating method. The central heating method means that the heating assembly is inserted into the interior of the aerosol generating substrate 100 to bake and heat the aerosol generating substrate 100 from the inside to the outside. The peripheral heating method means that the heating assembly is disposed on the periphery of the aerosol generating substrate 100 to bake and heat the aerosol generating substrate 100 from the outside to the inside. Specifically, the heating methods may include resistance heating, electromagnetic heating, infrared heating, microwave heating, laser heating, etc.

Exemplarily, the aerosol generating substrate 100 is subjected to microwave heating, and the wall of the aerosol generating substrate 100 may be used to absorb microwaves, and produce heat to generate the aerosol.

The specific structure of the aerosol generating substrate 100 is not limited herein. Exemplarily, in an embodiment, the aerosol generating substrate 100 may be made from an atomization medium itself, for example, from a smoke generating flavor medium. In other embodiments, the aerosol generating substrate 100 may also include a substrate body and an atomization medium disposed on the substrate body. The substrate body may be, for example, a high-temperature resistant carbon fiber. Thus, by providing the substrate body, the strength of the aerosol generating substrate 100 can be improved, and the aerosol generating substrate 100 can also withstand a certain degree of high temperature without generating any off odor.

The specific ingredients of the aerosol generating substrate 100 are not limited herein. Exemplarily, in an embodiment, the aerosol generating substrate 100 may include a plant ingredient, an auxiliary ingredient, a smoke-generating agent ingredient, a binder ingredient, and the like.

In one embodiment, the plant ingredient may include one or more combination of powders formed by crushing treatment on a tobacco leaf raw material, a tobacco leaf fragment, a tobacco stalk, a tobacco dust, and an aromatic plant. The plant ingredient may serve as the core source of article's flavor. Endogenous substances in the plant ingredient, such as nicotine, enter the human bloodstream via atomization, which promotes the pituitary gland to produce dopamine, thus achieving physiological satisfaction.

In one embodiment, the auxiliary ingredient may include one or more combinations of inorganic filler, a lubricant, and an emulsifier. Herein, the inorganic filler includes one or more combinations of heavy calcium carbonate, light calcium carbonate, zeolite, attapulgite, talc powder, and diatomaceous earth. The inorganic filler can provide skeleton support for the plant ingredient; and at the same time, since the inorganic filler also has micropore(s), which can improve the porosity of the wall material after the plant ingredient is molded, thereby increasing the aerosol release efficiency.

The lubricant includes one or more combinations of candelilla wax, carnauba wax, shellac, sunflower wax, rice bran, beeswax, stearic acid, and palmitic acid. The lubricant can enhance the fluidity of particles, reduce the friction between particles, promote more uniform overall density in particle distribution, and further decrease the pressure required for mold forming while reducing mold wear.

The emulsifier includes one or more combinations of polyglycerol fatty acid ester, Tween-80, and polyvinyl alcohol. To a certain extent, the emulsifier can mitigate the loss of flavor substances during storage, enhance the stability of flavor substances, and improve the sensory quality of articles. The emulsifier (also referred to as surfactants) can reduce the interfacial tension between water-soluble and water-insoluble components in the mixed system, and further form a robust film on a droplet surface or form a double electric layer on the droplet surface due to the charge(s) given by the emulsifier, which can prevent the droplet coalescence and maintain a uniform emulsion. Emulsification and homogenization of two immiscible components can improve the consistency of article quality.

The function of the smoke-generating agent ingredient may be to generate a large amount of vapor during heating, thereby increasing the smoke volume of the smoke-generating article. In an embodiment, the smoke-generating agent may include, for example, one or more combinations of a monohydric alcohol (such as menthol); a polyhydric alcohol (such as propylene glycol, triethylene glycol, 1, 3-butanediol, and glycerol); an ester of a polyhydric alcohol (such as gylcerol monoacetate, glycerol diacetate, or glyceryl triacetate); a monocarboxylic acid; a polycarboxylic acid (such as lauric acid, or myristic acid) or an aliphatic ester of polycarboxylic acid (such as dimethyl dodecanedioate, dimethyl tetradecanedioate, erythritol, 1, 3-butanediol, tetraethylene glycol, triethyl citrate, propylene carbonate, ethyl laurate, Triactin, racemic erythritol, glyceryl diacetate mixture, diethyl suberate, triethyl citrate, benzyl benzoate, benzyl phenylacetate, ethyl vanilate, glyceryl tributyrate, and lauryl acetate).

In one embodiment, the binder ingredient may include one or more combination of a natural plant extract, non-ionized modified viscous polysaccharide including one or more combinations of tamarind polysaccharide, pullulan polysaccharide, seaweed polysaccharide, locust bean gum, guar gum, and xyloglucan. The binder is in close contact with the interface of the component material of the article by wetting, resulting in intermolecular attraction, thereby playing the role of binding the powder, liquid, etc. of the component material. At the same time, the natural plants may be selected.

The extraction and non-ionization of the binder can prevent the release of harmful substances such as methanol, formaldehyde, and acrolein caused by colloid modification, which can improve the safety of articles.

In one embodiment, the wall may also include a wave absorbing material, and the wave absorbing material is the material with a high absorption rate for microwaves, which can be better suitable for microwave heating.

Exemplarily, the aerosol generating substrate 100 may be a particulate conjugate, which is a recombined tobacco medium, for example, a recombined tobacco medium containing ingredients such as a smoke-generating agent, a tobacco, and the like. The aerosol generating substrate 100 is an integrated structure, for example, an integrated structure that can be manufactured by an injection process, compression process, or extrusion process. Here, the extrusion process refers to a processing method where the raw material mixture is added into an extruder, the material is pushed forward by the screw through the action between the extruder barrel and the screw, and continuously passes through the die head to form articles or semi-finished articles of various cross sections. The aerosol substrate formed by the extrusion process is in the shape of a strip.

Since the aerosol generating substrate 100 is the particulate conjugate, the aerosol generating substrate 100 remains an integrated medium whether subjected to heat inhalation or after heat cessation, and the phenomenon of disintegration and falling is not easy to occur. This addresses issues presented in the existing flake-like, filamentous or loose-particle aerosol generating substrate 100, such as flake detachment, filamentous or particle components falling off, and difficulty in cleaning.

The shape of the aerosol generating substrate 100 is also not limited as long as the aerosol release channel can be provided. Exemplarily, referring to FIG. 1, the aerosol generating substrate 100 may be columnar. The shape of the cross-section of the columnar aerosol generating substrate 100 may be circular, polygonal (including but not limited to triangular, square, prismatic, etc.), elliptical, track-shaped, irregular shaped, etc. Herein, the irregular shaped refers to other symmetrical or asymmetrical shapes other than those listed above.

The aerosol release channel 10 is the channel through which the aerosol is extracted during the heating process, that is, the aerosol generated by heating the aerosol generating substrate 100 may enter the aerosol release channel 10 and may be discharged through the aerosol release channel 10.

There may be one or multiple aerosol release channels 10.

One end of the aerosol release channel 10 may be an open end penetrating a side of the aerosol generating substrate 100, and an opposite end of the aerosol release channel 10 may be a closed end. That is, the aerosol release channel 10 penetrates only one end of the aerosol generating substrate 100.

Alternatively, both ends of the aerosol release channel 10 that are opposite to each other may be open ends penetrating the aerosol generating substrate 100. That is, the aerosol release channel 10 penetrates both ends of the aerosol generating substrate 100.

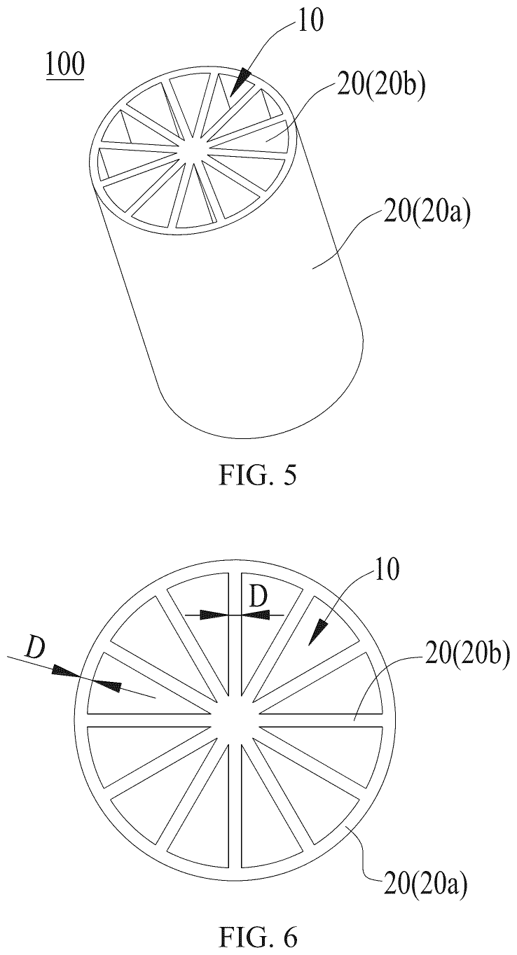

For the aerosol generating substrate 100 having a plurality of aerosol release channels 10, illustratively, referring to FIGS. 5 and 6, the aerosol release channels 10 may be disposed at intervals along a circumference direction of the aerosol generating substrate 100.

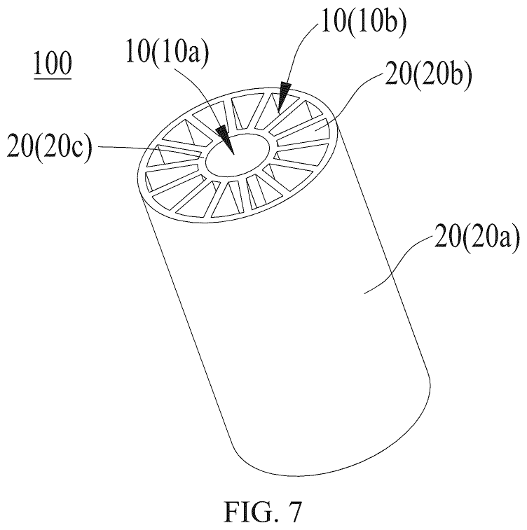

Exemplarily, referring to FIGS. 7 to 9, at least one aerosol release channel 10 may be disposed in the central region of the aerosol generating substrate 100, and the other aerosol release channels 10 may surround the aerosol release channel 10 disposed in the central region. For example, for ease of description, the aerosol release channels 10 shown in FIGS. 7 to 9 may be referred to as the first aerosol release channel 10a and the second aerosol release channel 10b, respectively. FIGS. 7 to 9 show only one first aerosol release channel 10a and a plurality of second aerosol release channels 10b, where the plurality of second aerosol release channels 10b surround the first aerosol release channel 10a. In other embodiments, a plurality of first aerosol release channels 10a may also be provided, and a plurality of second aerosol release channels 10b may surround the first aerosol release channels 10a.

The wall 20 for defining the aerosol release channel 10 may be equivalent to the side wall of the aerosol release channel 10, as shown in FIGS. 5 to 9. When there are a plurality of aerosol release channels 10, the portion of the aerosol generating substrate 100 for separating two adjacent aerosol release channels 10 (such portion may also be referred to as the partition wall between two adjacent aerosol release channels 10) may also be the wall 20 described in the embodiments of the present disclosure.

The specific thickness of the wall 20 may be adjusted according to the design requirements. For example, the thickness of the wall 20 may be 0.1 mm, 0.2 mm, 0.35 mm, 0.6 mm, 0.8 mm, 0.9 mm, 1.1 mm, or 1.2 mm.

If the thickness of the wall 20 is greater than 1.2 mm, the wall 20 becomes relatively thick, which potentially causes the cooling of the aerosol within the aerosol generating substrate 100 due to insufficient rapid extraction. If the thickness of the wall 20 is less than 0.1 mm, the wall 20 becomes relatively thin, the aerosol generated per unit area of the aerosol generating substrate 100 during the heating is insufficient to meet the inhalation demand of the user, and the aerosol generating substrate 100 is prone to deformation. If the shape of the cross section of the aerosol generating substrate 100 is circular, the roundness may be insufficient due to the deformation.

However, if the thickness of the wall 20 is set in the range from 0.1 mm to 1.2 mm, it can be conducive to the rapid release of the aerosol during the heating process, and can also ensure the carbonization rate of the aerosol generating substrate 100 while improving the aerosol extraction efficiency, thereby improving the utilization rate. In addition, in such thickness range, the aerosol generating substrate 100 can have sufficient structural strength and be less susceptible to deformation.

More preferably, the thickness of the wall 20 may be 0.3 mm to 0.5 mm (inclusive of endpoint values), for example, the thickness of the wall 20 may be 0.3 mm, 0.4 mm, or 0.5 mm. This dimensional range can not only ensure that the aerosol generating substrate 100 has a high structural strength while being more conducive to the rapid release of the aerosol generated by heating the aerosol generating substrate 100.

In one embodiment, the thickness difference of the wall 20 at different positions of the aerosol generating substrate 100 may be 0 to 100% (inclusive of endpoint values).

The different positions described herein may be on the same wall 20 or different wall bodies 20.

For example, taking the aerosol generating substrate 100 shown in FIGS. 1 to 4 as an example, when there is only one aerosol release channel 10, there may only be one wall 20 for defining the aerosol release channel 10, and the thickness difference at different positions of the wall 20 may be 0 to 100%. When the thickness difference at different positions of the wall 20 is 0, it is equivalent that the wall 20 is a uniform-thickness structure with the same thickness at any position. When the thickness difference at different positions of the wall 20 is greater than 0 and less than or equal to 100%, it is equivalent that the wall 20 is a non-uniform thickness structure with maximum and minimum thicknesses. Here, the thickness difference between the maximum value and the minimum value is greater than 0 and less than or equal to 100%.

For another example, taking the aerosol generating substrate 100 shown in FIGS. 5 and 6 as an example, when the aerosol generating substrate 100 includes the plurality of aerosol release channels 10, the wall 20 at different positions of the aerosol generating substrate 100 may be either different wall bodies 20 on the aerosol generating substrate 100 (such as the first wall 20a and any second wall 20b, or any two of the plurality of second wall bodies 20b shown in FIGS. 5 and 6), or the same wall 20 on the aerosol generating substrate 100 (such as the first wall 20a, or any one of the second walls 20b shown in FIGS. 5 and 6). In addition, when the thickness difference between different wall bodies 20 on the aerosol generating substrate 100 is greater than 0 and less than or equal to 100%, if there are both the non-uniform-thickness wall 20 and the uniform-thickness wall 20, the thickness difference between the thickness of the uniform-thickness wall 20 and the maximum thickness of the non-uniform-thickness wall 20 is greater than 0 and less than or equal to 100%, and the thickness difference between the thickness of the uniform-thickness wall 20 and the minimum thickness of the non-uniform-thickness wall 20 is also greater than 0 and less than or equal to 100%. If there are at least two non-uniform-thickness wall bodies 20, the thickness difference between the maximum thickness of any one of the two non-uniform-thickness wall bodies 20 and the minimum thickness of another one of the two non-uniform-thickness thickness wall bodies 20 is greater than 0 and less than or equal to 100%.

Exemplarily, the thickness difference of the wall 20 at different positions of the aerosol generating substrate 100 may be 0, 20%, 30%, 50%, 70%, 85%, or 100%.

The thickness difference of the wall 20 at different positions of the aerosol generating substrate 100 is 0 to 100%, which can facilitate processing and manufacturing. For example, taking the aerosol generating substrate 100 to be manufactured by the extrusion process as an example, during the extrusion process, it is possible to ensure that the difference in pressure borne by the force-receiving points at different extrusion positions of the extrusion die is small, and the aerosol generating substrate 100 can be completely extruded smoothly and stably. However, if the thickness difference of the wall 20 at different positions of the aerosol generating substrate 100 is greater than 100%, the aerosol generating substrate 100 extruded by the extrusion die may exhibit incomplete formation. For example, only a partial section of the aerosol generating substrate 100 may be extruded.

In one embodiment, for ease of description, for each aerosol release channel, a cross-sectional area of the aerosol release channel 10 may be denoted as S1, and a cross-sectional area of the wall 20 for defining the aerosol release channel 10 may be denoted as S2, and the ratio of S1 to S2 may be 1:1 to 5:1, that is, S1:S2=1:1 to 5:1 (inclusive of endpoint values).

Specifically, if the ratio of S1 to S2 is less than 1:1, the cross-sectional area of the aerosol release channel 10 is relatively small, the pressure of the aerosol release channel 10 during the aerosol extraction is relatively high, and the airflow speed is too fast. Thus, the aerosol generation substrate 100 starts to release the aerosol before being heated sufficiently, which leads to partial aerosol condensation within the aerosol generation substrate 100 and incomplete extraction. If the ratio of S1 to S2 is greater than 5:1, the cross-sectional area of the aerosol release channel 10 is too large, the pressure of the aerosol release channel 10 during the aerosol extraction is relatively low, and the airflow speed is relatively slow, which is not conductive to the aerosol extraction.

Exemplarily, the ratio of S1 to S2 may be 1:1, 2.5:1, 3:1, 4:1, or 5:1.

When the ratio of S1 to S2 is in the range of 1:1 to 5:1, the pressure of the aerosol release channel 10 during the aerosol extraction is moderate, and the airflow speed is also moderate, so that the aerosol generated by the aerosol generating substrate 100 per unit area during heating can be extracted sufficiently and rapidly.

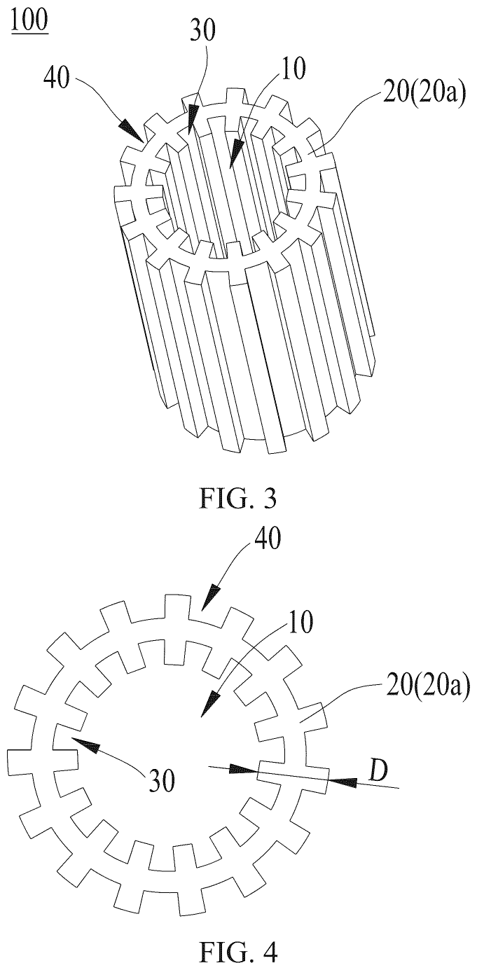

In one embodiment, referring to FIGS. 3 and 4, for ease of description, the wall 20 that defines an outer contour of the aerosol generating substrate 100 can be referred to as the first wall 20a. A portion of an inner surface of the first wall 20a may be recessed toward an outer side of the aerosol generating substrate 100, to enable a plurality of first grooves 30 to be formed on an inner peripheral side of the first wall 20a. The plurality of first grooves 30 are spaced apart

The regions of the first wall 20a on which the first grooves 30 are provided may be equivalent to reducing the thickness of the first wall 20a at those positions. The aerosol generated by heating the aerosol generating substrate 100 can be rapidly released through the first grooves 30 to facilitate the user inhalation.

The first grooves 30 may be suitably provided for the first wall 20a with a relatively large thickness, such as the first wall 20a with a thickness of 0.5 mm to 1.2 mm (inclusive of endpoint values).

With continued reference to FIGS. 3 and 4, a portion of an outer surface of the first wall 20a may also be recessed toward an inner side of the aerosol generating substrate 100, to enable a plurality of second grooves 40 to be formed on an outer peripheral side of the first wall 20a. The plurality of second grooves 40 are spaced apart.

Similar to the first grooves 30, the regions of the first wall 20a on which the second grooves 4 are provided may also be equivalent to reducing the thickness of the first wall 20a at those positions. The aerosol generated by heating the aerosol generating substrate 100 can be rapidly released through the second grooves 40 to facilitate the user inhalation.

The second grooves 40 may also be suitably provided for the first wall 20a with a relatively large thickness, such as the first wall 20a with a thickness of 0.5 mm to 1.2 mm (inclusive of endpoint values).

In FIGS. 3 and 4, the first wall 20a is provided with the first grooves 30 and the second grooves 40 at the same time. Preferably, the first grooves 30 and the second grooves 40 may be oppositely arranged in a one-to-one correspondence along a thickness direction of the first wall 20a, which means that the outer side of the positions of the first wall 20a on which the first grooves 30 are provided may be the positions of the second grooves 40. This arrangement mode can ensure that the first wall 20a has sufficient structural strength, while allowing the portion of the first wall 20a between the first groove 30 and the second groove 40 to have a small thickness, which can be more conducive to the rapid release of aerosol.

In some embodiments, the first grooves 30 and the second grooves 40 may also be disposed staggered.

It should be noted that the first wall 20a is not limited to providing the first grooves 30 and the second grooves 40 at the same time. In some embodiments, only the first grooves 30 or only the second grooves 40 may be provided.

In addition, FIGS. 3 and 4 show that the first grooves 30 and the second grooves 40 are provided on the first wall 20a of the aerosol generating substrate 100 including only one aerosol release channel 10. In other embodiments, at least one of the first groove 30 and the second groove 40 may also be provided on the first wall 20a of the aerosol generating substrate 100 including the plurality of aerosol release channels 10.

In some embodiments, the air hole may be provided on the wall 20 as needed. There may be one or multiple air holes, and the installation position and installation mode of the air hole are not limited. For example, the air hole may penetrate at least one of the opposite ends of the wall 20, may penetrate at least one of the inner surface and the outer surface of the wall 20, or may be provided in the interior of the wall 20 without penetrating any position of the wall 20. It should be noted that the air hole described in the embodiments of the present disclosure belong to the holes in a macroscopic sense, and the air hole may be mainly formed by processing. Therefore, the dimensions such as the cross-sectional area and the length of the air hole can be changed according to design requirements. The presence of the air hole may also be more conducive to the rapid release of aerosol.

In one embodiment, referring to FIGS. 5 to 8, for the aerosol generating substrate 100 including the plurality of aerosol release channels 10, each of the aerosol release channels 10 may be collectively defined by different wall bodies 20.

Exemplarily, referring to FIGS. 5 and 6, for ease of description, the different wall bodies 20 in FIGS. 5 and 6 may be referred to as the first wall 20a and the second wall 20b, respectively. The first wall 20a defines the outer contour of the aerosol generating substrate 100 and a hollow region located inside the aerosol generating substrate 100, and the second wall 20b is disposed in the hollow region to partition the hollow region into at least two aerosol release channels 10.

In other words, at least two aerosol release channels 10 may be formed by providing the first wall 20a and the second wall 20b.

In FIGS. 5 and 6, there are a plurality of second wall bodies 20b, one side of each of the plurality of second wall bodies 20b is respectively connected to the first wall 20a, and an opposite side of each of the plurality of second wall bodies 20b is interconnected with each other. That is, the second wall bodies 20b are arranged radially within the hollow region, and each aerosol release channel 10 is collectively defined by the first wall 20a and two adjacent second wall bodies 20b.

In other embodiments, only one second wall 20b may be provided, and opposite sides of the second wall 20b are respectively connected to the first wall 20a, thereby partitioning the hollow region into two aerosol release channels 10.

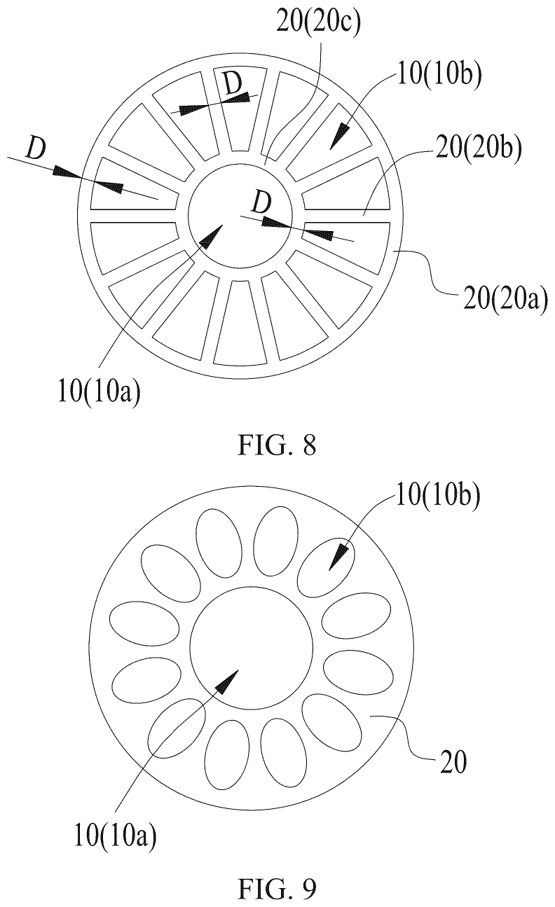

Exemplarily, referring to FIGS. 7 and 8, for ease of description, the different wall bodies 20 in FIGS. 7 and 8 may be referred to as the first wall 20a, the, the second wall 20b and the third wall 20c, respectively. There are a plurality of the second walls 20b, the third wall 20c is in annular shape, and the first wall 20a defines the outer contour of the aerosol generating substrate 100 and the hollow region located inside the aerosol generating substrate 100. The plurality of second wall bodies 20b and the third wall 20c may be all disposed in the hollow region, one side of each of the second wall bodies 20b is respectively connected to the first wall 20a, and an opposite side of each of the second wall bodies 20b is respectively connected to the third wall 20c. The first aerosol release channel 10a may be defined in the third wall 20c; and the second aerosol release channels 10b may be collectively defined by the first wall 20a, the third wall 20c and two adjacent second wall bodies 20b.

In other words, the first wall 20a, the second wall bodies 20b, and the third wall 20c may be provided to form the first aerosol release channel 10a and the plurality of second aerosol release channels 10b surrounding the first aerosol release channel 10a described in the previous embodiments.

It should be noted that, for the aerosol generating substrate 100 including the plurality of aerosol release channels 10, each of the aerosol release channels 10 may not be collectively defined by different wall bodies 20. For example, referring to FIG. 9, the aerosol generating substrate 100 in FIG. 9 also includes the plurality of aerosol release channels 10, but the aerosol generating substrate 100 does not distinctly partition the different wall bodies 20.

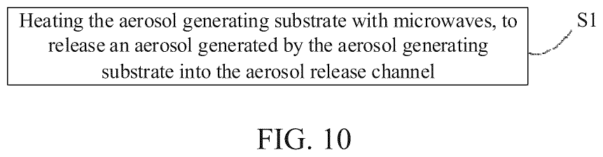

The embodiments of the present disclosure also provide a microwave heating method, used for the aerosol generating substrate 100 provided by any embodiment of the present disclosure. Referring to FIG. 10, the method includes the following operation.

At operation S1, the aerosol generating substrate is heated with microwaves to release an aerosol generated by the aerosol generating substrate into the aerosol release channel.

Specifically, taking the aerosol generating substrate 100 shown in FIGS. 1 to 9 as an example, during the microwave heating process, a microwave field penetrates into the solid structure of the aerosol generating substrate 100. The polar molecules in the aerosol generating substrate 100 move under the action of microwaves and generate heat. Upon heating, the aerosol is generated by heating the aerosol generating substrate 100, the generated aerosol enters the aerosol release channel 10, and is discharged through the aerosol release channel 10.

It should be noted that microwave heating is only one feasible heating method. In other application scenarios, the aerosol generating substrate 100 can also be heated by using other heating methods.

In one embodiment, for the aerosol generating substrate including the plurality of aerosol release channels, a part of the wall defining the plurality of aerosol release channels may be heated each time.

Taking the aerosol generating substrate 100 shown in FIGS. 5 and 6 as an example, exemplarily, the microwaves may mainly heat the wall 20 for one aerosol release channel 10 each time, which enables the aerosol to be mainly released into the aerosol release channel 10 defined by the wall 20 that is heated. Upon the completion of heating at one time (e.g., after a user puffs once or the certain time number of puffs), the microwaves then mainly heat the wall 20 for another aerosol release channel 10.

Exemplarily, the part of the wall 20 defining more than one aerosol release channel 10 (i.e., the number of heated aerosol release channels 10 is greater than one and less than the total number of aerosol release channels 10) may be heated by the microwaves at one time. Upon the completion of heating at one time (e.g., after the user puffs once or the certain time number of puffs), another part of the wall 20 defining the aerosol release channels 10 may be heated by the microwaves.

The aerosol generating device may be provided with a rotation assembly. After the heating assembly finishes the heating of the wall 20 for the corresponding aerosol release channel 10, the rotation assembly may drive the aerosol generating substrate 100 to rotate, so that other aerosol release channels 10 of the aerosol generating substrate 100 may rotate to the positions corresponding to the microwave fields generated by the heating assembly. In such way, the composition and temperature of the aerosol generated by heating the wall 20 by the heating assembly at different times can be relatively consistent, which can ensure higher flavor consistency during the user inhalation.

Since the aerosol generating substrate 100 in the embodiments of the present disclosure can fully and rapidly release the aerosol during the heating process, it is only necessary to heat the wall 20 for some of the plurality of aerosol release channels 10 each time, to satisfy the demand for user inhalation. Moreover, such heating method can increase the total heating times for the aerosol generating substrate 100, which may be equivalent to increasing the number of inhalations available to the user, and further can improve the user experience.

In some embodiments, all of the aerosol release channels 10 may also be heated simultaneously.

In one embodiment, for the aerosol generating substrate including the first aerosol release channel and the second aerosol release channels, the part of the wall defining the plurality of second aerosol release channels may also be heated at a time.

Taking the aerosol generating substrate 100 shown in FIGS. 7 to 9 as an example, the aerosol may be mainly released into the second aerosol release channels 10b defined by the heated wall 20, and a small amount of aerosol may be released into the first aerosol release channel 10a. That is, only the wall 20 for the second aerosol release channels 10b is heated, while the wall 20 for the first aerosol release channel 10a may not be heated. It should be note that, for the wall 20 located between the first aerosol release channel 10a and the second aerosol release channels 10b, such as the third wall 20c shown in FIGS. 7 and 8, the side of the wall 20 close to the second aerosol release channels 10b may be heated, and the side of the wall 20 close to the first aerosol release channel 10a may not be heated.

Exemplarily, only the wall 20 for one second aerosol release channel 10b may be heated by the microwaves at a time, which enables the aerosol to be mainly released into the second aerosol release channel 10b defined by the heated wall 20, and a small amount of aerosol may be released into the first aerosol release channel 10a. Upon the completion of heating at one time (e.g., after the user puffs once or the certain number of puffs), the wall 20 for another second aerosol release channel 10b may be heated by the microwaves.

Exemplarily, a part of the wall 20 defining more than one second aerosol release channel 10b (i.e., the number of the heated second aerosol release channels 10b is greater than one and less than the total number of second aerosol release channels 10b) may be heated by the microwaves at one time. Upon the completion of heating at one time (e.g., after the user puffs once or the certain time number of puffs), another part of the wall 20 defining the second aerosol release channels 10b may be heated by the microwaves.

Similar to the previous embodiments, it is only necessary to heat the part of the wall 20 defining the plurality of second aerosol release channels 10b each time, to satisfy the demand for user inhalation. Moreover, such heating method can also increase the total heating times for the aerosol generating substrate 100, which can be equivalent to increasing the number of inhalations available to the user, thereby improving the user experience.

In some embodiments, all of the second aerosol release channels 10b may also be heated simultaneously.

In some embodiments, the wall 20 for the first aerosol release channel 10a may also be heated.

In the description of the present disclosure, a description with reference to the terms “in one embodiment”, “in some embodiments”, “in other embodiments”, “in still other embodiments”, or “exemplary” or the like means that a specific feature, structure, material, or characteristic described in conjunction with the embodiment or example is included in at least one embodiment or example of the embodiments of the present disclosure. In the present disclosure, the illustrative expression of the above terms is not necessarily directed to the same embodiment or example. Moreover, the specific feature, structure, material, or characteristic described may be combined in any one or more embodiments or examples in a suitable manner. Furthermore, those skilled in the art can combine different embodiments or examples described in the present disclosure and features of different embodiments or examples without contradicting each other.

The foregoing is intended to illustrate merely preferred embodiments of the present disclosure, and is not intended to limit the present disclosure. Those skilled in the art can appreciate that various modifications and variations can be made to the present disclosure. Any modification, equivalent substitution, improvement, etc. made within the spirit and principle of the present disclosure shall be included within the scope of protection of the present disclosure.

1. An aerosol generating substrate, comprising at least one aerosol release channel, wherein a thickness of a wall of the aerosol generating substrate defining the aerosol release channel is 0.1 mm to 1.2 mm.

2. The aerosol generating substrate of claim 1, wherein the thickness of the wall is 0.3 mm to 0.5 mm.

3. The aerosol generating substrate of claim 1, wherein a thickness difference of the wall at different positions of the aerosol generating substrate is 0 to 100%; and/or,
the aerosol generating substrate is manufactured by extrusion process.

4. The aerosol generating substrate of claim 1, wherein for each aerosol release channel, a cross-sectional area of the aerosol release channel is S1, a cross-sectional area of the wall for defining the aerosol release channel is S2, and S1:S2=1:1 to 5:1.

5. The aerosol generating substrate of claim 1, wherein the wall comprises a first wall, and the first wall defines an outer contour of the aerosol generating substrate;
a portion of an inner surface of the first wall is recessed toward an outer side of the aerosol generating substrate, to enable a plurality of first grooves to be formed on an inner peripheral side of the first wall, wherein the plurality of first grooves are spaced apart; and/or,
a portion of an outer surface of the first wall is recessed toward an inner side of the aerosol generating substrate, to enable a plurality of second grooves to be formed on an outer peripheral side of the first wall, wherein the plurality of second grooves are spaced apart.

6. The aerosol generating substrate of claim 5, wherein the aerosol generating substrate comprises the plurality of first grooves and the plurality of second grooves, and the plurality of first grooves and the plurality of second grooves are oppositely arranged in a one-to-one correspondence along a thickness direction of the wall.

7. The aerosol generating substrate of claim 1, wherein the wall comprises a first wall and a second wall, the first wall defines an outer contour of the aerosol generating substrate and a hollow region located inside the aerosol generating substrate, and the second wall is disposed in the hollow region to partition the hollow region into at least two aerosol release channels.

8. The aerosol generating substrate of claim 7, wherein there are a plurality of second wall bodies; one side of each of the plurality of second wall bodies is respectively connected to the first wall, and an opposite side of each of the plurality of second wall bodies is interconnected with each other.

9. The aerosol generating substrate of claim 1, wherein the aerosol release channel comprises at least one first aerosol release channel and a plurality of second aerosol release channels, and the plurality of second aerosol release channels surround the first aerosol release channel.

10. The aerosol generating substrate of claim 9, wherein the wall comprises a first wall, a plurality of second wall bodies, and a third wall in an annular shape; the first wall defines an outer contour of the aerosol generating substrate and a hollow region located inside the aerosol generating substrate; the plurality of second wall bodies and the third wall are all disposed in the hollow region; one side of each of the second wall bodies is respectively connected to the first wall, and an opposite side of each of the second wall bodies is respectively connected to the third wall; the first aerosol release channel is defined in the third wall, and the second aerosol release channels are collectively defined by the first wall, the third wall and two adjacent second wall bodies.

11. The aerosol generating substrate of claim 1, wherein the wall is provided with an air hole.

12. The aerosol generating substrate of claim 1, wherein the wall comprises a wave absorbing material; and/or,
the wall is configured to absorb microwaves and produce heat to generate an aerosol.

13. The aerosol generating substrate of claim 1, wherein one end of the aerosol release channel is an open end penetrating a side of the aerosol generating substrate, and an opposite end of the aerosol release channel is a closed end; and/or,
both ends of the aerosol release channel that are opposite to each other are open ends penetrating the aerosol generating substrate.

14. A microwave heating method, used for an aerosol generating substrate, the method comprising:
heating an aerosol generating substrate with microwaves to release an aerosol generated by the aerosol generating substrate into the aerosol release channel defined by a wall of the aerosol generating substrate, wherein a thickness of the wall is 0.1 mm to 1.2 mm.

15. The microwave heating method of claim 14, wherein there are a plurality of aerosol release channels, and the method further comprises:
heating a part of the wall defining the plurality of aerosol release channels each time.

16. The microwave heating method of claim 14, wherein the aerosol release channel comprises at least one first aerosol release channel and a plurality of second aerosol release channels, the plurality of second aerosol release channels surround the first aerosol release channel; and the method further comprises:
heating a part of the wall defining the plurality of second aerosol release channels each time.

17. The aerosol generating substrate of claim 2, wherein a thickness difference of the wall at different positions of the aerosol generating substrate is 0 to 100%; and/or,
the aerosol generating substrate is manufactured by extrusion process.

18. The aerosol generating substrate of claim 2, wherein for each aerosol release channel, a cross-sectional area of the aerosol release channel is S1, a cross-sectional area of the wall for defining the aerosol release channel is S2, and S1:S2=1:1 to 5:1.

19. The aerosol generating substrate of claim 2, wherein the wall comprises a first wall, and the first wall defines an outer contour of the aerosol generating substrate;
a portion of an inner surface of the first wall is recessed toward an outer side of the aerosol generating substrate, to enable a plurality of first grooves to be formed on an inner peripheral side of the first wall, wherein the plurality of first grooves are spaced apart; and/or,
a portion of an outer surface of the first wall is recessed toward an inner side of the aerosol generating substrate, to enable a plurality of second grooves to be formed on an outer peripheral side of the first wall, wherein the plurality of second grooves are spaced apart.

20. The aerosol generating substrate of claim 2, wherein the wall comprises a first wall and a second wall, the first wall defines an outer contour of the aerosol generating substrate and a hollow region located inside the aerosol generating substrate, and the second wall is disposed in the hollow region to partition the hollow region into at least two aerosol release channels.
